(19) United States
(12) Patent Application Publication
(10) Pub. No.: US 2025/0119779 A1
(43) Pub. Date: Apr. 10, 2025

(54) RADIO INFORMATION MEASUREMENT SYSTEM, RADIO INFORMATION MEASUREMENT METHOD, SERVER DEVICE AND SERVER PROGRAM

(71) Applicant: NIPPON TELEGRAPH AND TELEPHONE CORPORATION, Tokyo (JP)

(72) Inventors: Masayoshi NABESHIMA, Tokyo (JP); Tomoaki OGAWA, Tokyo (JP)

(73) Assignee: NIPPON TELEGRAPH AND TELEPHONE CORPORATION, Tokyo (JP)

(21) Appl. No.: 18/865,679

(22) PCT Filed: May 27, 2022
(86) PCT No.: PCT/JP2022/021794

§ 371 Date: Nov. 14, 2024

(51) Int. Cl. H04W 24/10; H04B 17/318; H04B 17/373

(52) U.S. Cl. CPC H04W 24/10; H04B 17/318; H04B 17/373

(57) ABSTRACT

A radio wave information measurement system according to an embodiment: stores predicted values of radio wave information, the predicted values being predicted, by each of a plurality of users, to be measured at a respective plurality of measurement positions preset in a predetermined area; receives measured values of the radio wave information, the measured values being measured at the respective plurality of measurement positions by each of wireless terminals; calculates, for each of the plurality of measurement positions, a difference between a predicted value and a measured value for each user; calculates, for each user, an accumulated value of differences calculated; calculates a score for each user such that a score value increases as the accumulated value decreases; and transmits scores of the plurality of users calculated to each of the wireless terminals, and each of the wireless terminals displays the scores of the plurality of users transmitted.

### TECHNICAL FIELD

The present invention relates to a radio wave information measurement system, a radio wave information measurement method, a server device, and a server program.

### BACKGROUND ART

For example, when a wireless network such as a wireless LAN is designed, a site survey is performed. The site survey is, for example, a radio wave survey conducted by a worker (user). Specifically, the site survey is performed to determine the number of base stations (access points: APs) installed, installation positions, radio wave intensities, channels to be used, and the like when a wireless LAN is newly constructed.

In addition, an attempt (gamification) to improve motivation of the user by applying elements and rules used in games to work performed by the worker (user) has been studied (see, for example, Non Patent Literature 1).

In addition, as an example of a tool including a game-like element, there is typing software (see, for example, Non Patent Literature 2). The typing software can advantageously advance the game when the user correctly inputs characters displayed on the screen from a keyboard. Then, the user can enjoy and efficiently learn a keyboard input skill by utilizing the game-like element.

### CITATION LIST

### Non Patent Literature

Non Patent Literature 1: “Business genba deno gamification katsuyou gijutsu to kensho (in Japanese) (Gamification Utilization Technology and Verification in Business Site)”, NTT Technical Journal, April 2015, pp. 42-45
Non Patent Literature 2: “TOKUUCHI”, [online], SOURCENEXT CORPORATION, [Searched on Mar. 10, 2022], Internet <URL: https://www.sourcenext.com/product/pc/tok/pc_tok_003059/>

### SUMMARY OF INVENTION

### Technical Problem

For example, in the site survey described above, each of engineers (users) should learn a skill of “selecting the number of installed APs, installation locations, and radio wave measurement positions by looking at an entire floor diagram for constructing a wireless LAN” performed by a senior engineer.

However, in the site survey, there has been a problem that each engineer ends up with simple work of “move to each of a plurality of measurement positions and simply measure radio waves”, which does not lead to motivation to develop the skill described above.

The present invention has been made in view of the above-described problem, and an object of the present invention is to provide a radio wave information measurement system, a radio wave information measurement method, a server device, and a server program capable of measuring radio wave information in construction of a wireless network and actively acquiring a skill necessary for constructing a wireless network.

### Solution to Problem

A radio wave information measurement system according to an embodiment of the present invention is a radio wave information measurement system in which a plurality of users measures radio wave information regarding a radio wave transmitted by each of a plurality of base stations arranged at different positions in a predetermined area by respectively using wireless terminals that perform wireless communication with the base stations, the radio wave information measurement system including: a storage unit that stores each of predicted values of the radio wave information, the predicted values being predicted, by each of the plurality of users, to be measured at a respective plurality of measurement positions preset in the predetermined area; a reception unit that receives each of measured values of the radio wave information, the measured values being measured at the respective plurality of measurement positions by each of the wireless terminals; a difference calculation unit that calculates, for each of the plurality of measurement positions, a difference between a predicted value stored in the storage unit and a measured value received by the reception unit for each user; an accumulated-value calculation unit that calculates, for each user, an accumulated value of differences calculated for each of the plurality of measurement positions by the difference calculation unit; a score calculation unit that calculates a score for each user such that a score value increases as the accumulated value calculated by the accumulated-value calculation unit decreases; and a transmission unit that transmits scores of the plurality of users calculated by the score calculation unit to each of the wireless terminals, in which each of the wireless terminals includes a display unit that displays each of the scores of the plurality of users transmitted by the transmission unit.

In addition, a radio wave information measurement method according to an embodiment of the present invention is a radio wave information measurement method in which a plurality of users measures radio wave information regarding a radio wave transmitted by each of a plurality of base stations arranged at different positions in a predetermined area by respectively using wireless terminals that perform wireless communication with the base stations, the radio wave information measurement method including: a step of causing a storage unit to store each of predicted values of the radio wave information, the predicted values being predicted, by each of the plurality of users, to be measured at a respective plurality of measurement positions preset in the predetermined area; a step of receiving each of measured values of the radio wave information, the measured values being measured at the respective plurality of measurement positions by each of the wireless terminals; a step of calculating, for each of the plurality of measurement positions, a difference between a predicted value stored in the storage unit and a measured value received, for each user; a step of calculating, for each user, an accumulated value of differences calculated for each of the plurality of measurement positions; a step of calculating a score for each user such that a score value increases as the accumulated value calculated decreases; a step of transmitting scores of the plurality of users calculated to each of the wireless terminals; and a step in which each of the wireless terminals displays the scores of the plurality of users transmitted.

In addition, a server device according to an embodiment of the present invention is a server device whose clients are a plurality of wireless terminals that performs wireless communication with a plurality of base stations, the server device including: a storage unit that stores each of predicted values of radio wave information regarding a radio wave transmitted by each of the plurality of base stations arranged at different positions in a predetermined area, the predicted values being predicted, by a plurality of users, to be measured by each of the wireless terminals at a respective plurality of measurement positions preset in the predetermined area; a reception unit that receives each of measured values of the radio wave information, the measured values being measured at the respective plurality of measurement positions by each of the wireless terminals; a difference calculation unit that calculates, for each of the plurality of measurement positions, a difference between a predicted value stored in the storage unit and a measured value received by the reception unit for each user; an accumulated-value calculation unit that calculates, for each user, an accumulated value of differences calculated for each of the plurality of measurement positions by the difference calculation unit; a score calculation unit that calculates a score for each user such that a score value increases as the accumulated value calculated by the accumulated-value calculation unit decreases; and a transmission unit that transmits scores of the plurality of users calculated by the score calculation unit to each of the wireless terminals.

### Advantageous Effects of Invention

According to the present invention, it is possible to measure radio wave information in construction of a wireless network and actively acquire a skill necessary for constructing a wireless network.

### BRIEF DESCRIPTION OF DRAWINGS

FIG. 1 is a functional block diagram illustrating functions of a wireless terminal included in a radio wave information measurement system according to an embodiment.

FIG. 2 is a functional block diagram illustrating functions of a server device included in the radio wave information measurement system according to the embodiment.

FIG. 3 is a flowchart illustrating processing executed by a game execution unit of the server device.

FIG. 4 is a display example of a game screen displayed by a display unit.

FIG. 5 is a diagram illustrating operation timing of each of wireless terminals in the radio wave information measurement system.

FIG. 6 is a diagram illustrating a predicted value of each of users at each of measurement positions.

FIG. 7 (a) is a diagram illustrating values of RSSIs detected by a wireless terminal. FIG. 7 (b) is a diagram illustrating values of RSSIs detected by a wireless terminal. FIG. 7 (c) is a diagram illustrating values of RSSIs detected by a wireless terminal.

FIG. 8 is a display example of the game screen displayed by the display unit.

FIG. 9 is a diagram illustrating a hardware configuration example of the server device according to the embodiment.

FIG. 10 is a diagram illustrating a usage example of the radio wave information measurement system.

FIG. 11 is a diagram illustrating a specific configuration example of the radio wave information measurement system.

### DESCRIPTION OF EMBODIMENTS

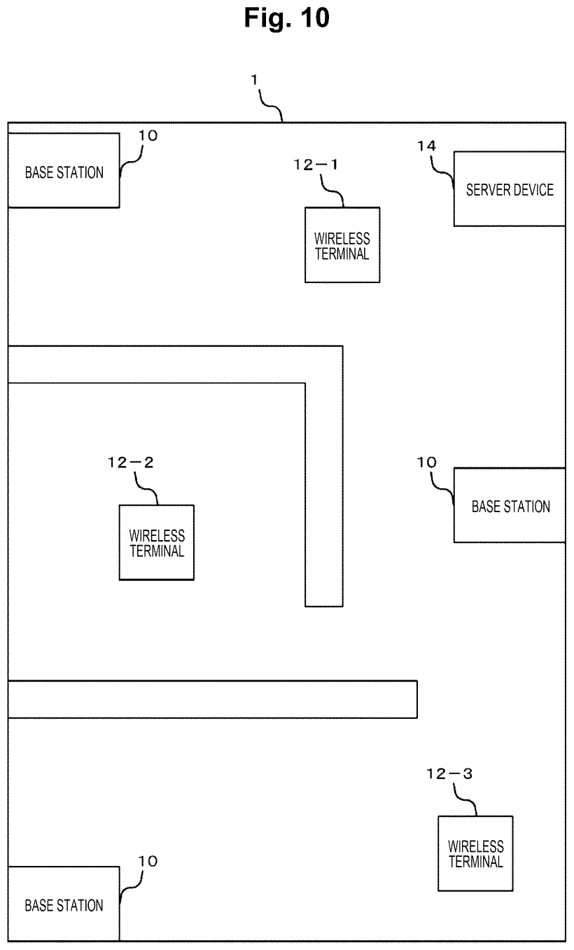

First, the background of the present invention will be described. FIG. 10 is a diagram illustrating a usage example of a radio wave information measurement system. As illustrated in FIG. 10, the radio wave information measurement system is configured such that, for example, three engineers (users) measure radio wave information regarding a radio wave transmitted by each of base stations 10 arranged in a predetermined area 1 indoors or outdoors, for example, by respectively using wireless terminals 12-1 to 12-3 that perform communication with the base stations 10 by, for example, a wireless LAN, and measurement results are transmitted to a server device 14. Note that the number of base stations and the number of wireless terminals (the number of users) are any numbers, but are each three here.

For the base stations 10, the number of installations, installation locations, and measurement points (measurement positions) of radio waves are selected by a senior engineer having a skill necessary for constructing a wireless network on the basis of a drawing of the predetermined area 1 (for example, a floor) to be a target for constructing a wireless LAN.

The wireless terminals 12-1 to 12-3 are used as site survey tools for detecting, for example, a received signal strength indicator (RSSI) as information regarding a radio wave transmitted by each of the base stations 10.

Each engineer (user) determines a measurement position of a radio wave to be in charge, and causes a site survey tool (wireless terminal) to read the drawing of the floor to be in charge. Then, each engineer sequentially moves to the measurement position of radio waves to be in charge, measures radio wave information by using the site survey tool, and transmits a measurement result to the server device 14. The server device 14 visualizes and displays the radio wave information transmitted from each site survey tool.

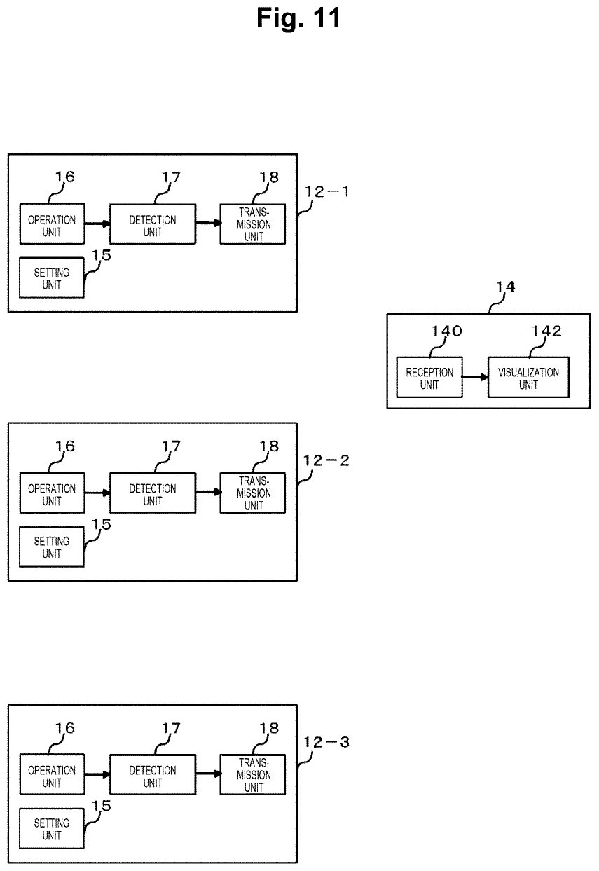

FIG. 11 is a diagram illustrating a specific configuration example of the radio wave information measurement system. The radio wave information measurement system includes, for example, the wireless terminals 12-1 to 12-3 and the server device 14. In a case where a particular one of a plurality of components such as the wireless terminals 12-1 to 12-3 is not specified, the wireless terminals are simply referred to as wireless terminals 12 or the like.

Each wireless terminal 12 include a setting unit 15, an operation unit 16, a detection unit 17, and a transmission unit 18. The setting unit 15 performs setting for the wireless terminal 12. For example, the setting unit 15 takes a drawing of a floor on which the site survey is performed into the wireless terminal 12 in response to an operation on the operation unit 16 by the user.

The operation unit 16 is a user interface that accepts a user's operation, and causes the detection unit 17 to start an operation, for example, when the user moves to the measurement position of radio waves and clicks on the drawing that matches a current location of the user.

When the user clicks on the operation unit 16, the detection unit 17 starts measurement of radio wave information. For example, the detection unit 17 scans channels, detects an RSSI or the like of a radio wave transmitted by each base station 10, and outputs the detected RSSI or the like to the transmission unit 18.

The transmission unit 18 transmits the radio wave information such as the RSSI detected by the detection unit 17 to the server device 14.

Then, the user repeats, in the predetermined area 1, work of moving to another measurement position, similarly performing an operation on the operation unit 16, performing measurement of the radio wave information by the wireless terminal 12, and transmitting a measurement result to the server device 14.

The server device 14 includes, for example, a reception unit 140 and a visualization unit 142. The reception unit 140 receives each of pieces of radio wave information measured at a plurality of measurement positions by each user, and outputs the received information to the visualization unit 142. The visualization unit 142 visualizes a radio wave state in the entire predetermined area 1 on the basis of the radio wave information input from the reception unit 140.

It is desirable that each user actively acquire a skill necessary for constructing a wireless network when performing a site survey. Here, acquiring a skill necessary for constructing a wireless network is considered to be in agreement with a fact that the user can predict that if a base station 10 is installed at this position, a maximum value of a received signal strength indicator (RSSI) will be about this value at a certain point (measurement position) when looking at the drawing of the predetermined area 1.

Thus, a radio wave information measurement system according to an embodiment is configured such that a game-like element is added and it is enabled to improve motivation of a user to develop a skill necessary for constructing a wireless network.

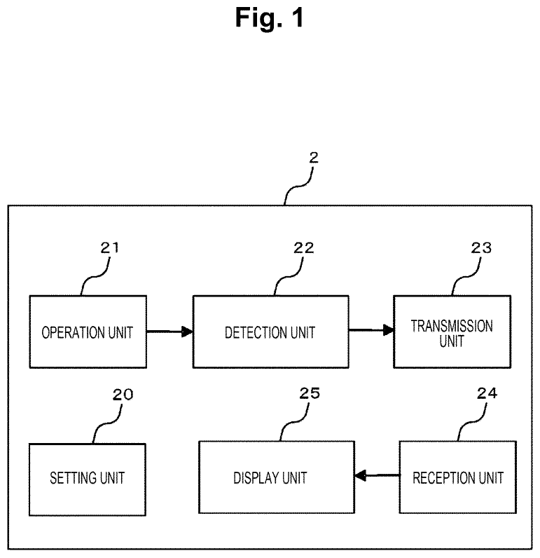

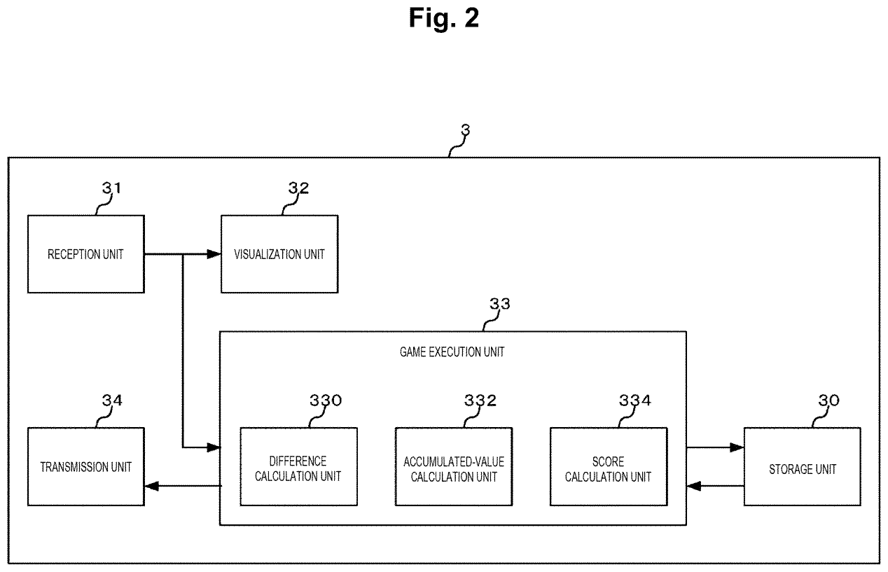

FIG. 1 is a functional block diagram illustrating functions of a wireless terminal 2 included in the radio wave information measurement system according to the embodiment. FIG. 2 is a functional block diagram illustrating functions of a server device 3 included in the radio wave information measurement system according to the embodiment. A plurality of the wireless terminals 2 and the server device 3 are used in place of the wireless terminals 12-1 to 12-3 and the server device 14 in the predetermined area 1 illustrated in FIG. 10 to constitute the radio wave information measurement system according to the embodiment.

As illustrated in FIG. 1, the wireless terminal 2 serving as a client includes a setting unit 20, an operation unit 21, a detection unit 22, a transmission unit 23, a reception unit 24, and a display unit 25.

The setting unit 20 takes a drawing of a floor on which the site survey is performed into the wireless terminal 2 in response to an operation on the operation unit 21 by the user.

The operation unit 21 is, for example, a user interface such as a touch panel capable of displaying a drawing for accepting a user's operation, and causes the detection unit 22 to start an operation when, for example, the user moves to a radio wave measurement position and clicks on the drawing that matches a current location of the user.

When the user clicks on the operation unit 21, the detection unit 22 starts measurement of radio wave information. For example, the detection unit 22 scans channels, detects (measures) an RSSI and the like of a radio wave transmitted by each of the plurality of base stations 10, and outputs a detected result to the transmission unit 23 as the radio wave information.

The transmission unit 23 transmits the radio wave information such as the RSSI detected by the detection unit 22 to the server device 3.

Then, the user repeats, in the predetermined area 1, work of moving to another measurement position, similarly performing an operation on the operation unit 21, performing measurement of the radio wave information by the wireless terminal 2, and transmitting a measurement result to the server device 3.

The reception unit 24 receives information transmitted from the server device 3 and outputs the information to the display unit 25.

The display unit 25 displays the information received by the reception unit 24. For example, the display unit 25 displays each of scores (described later) of a plurality of users transmitted by the server device 3. In addition, as illustrated in FIG. 2, the server device 3 includes a storage unit 30, a reception unit 31, a visualization unit 32, a game execution unit 33, and a transmission unit 34.

In addition, the storage unit 30 stores each of predicted values of the radio wave information, the predicted values being predicted, by each of the plurality of users, to be measured at a respective plurality of measurement positions preset in the predetermined area 1. For example, each user predicts a maximum value of the RSSI predicted to be measured at each of the plurality of measurement positions. Specifically, the storage unit 30 stores an electronic file in which a user name, a measurement position (detection position), and an expected value are described.

The reception unit 31 receives each of measured values of the radio wave information, the measured values being detected (measured) at the respective plurality of measurement positions by each of the wireless terminals 2, and outputs the measured values to the visualization unit 32 and the game execution unit 33.

The visualization unit 32 visualizes a radio wave state in the entire predetermined area 1 on the basis of the radio wave information input from the reception unit 31.

The game execution unit 33 includes a difference calculation unit 330, an accumulated-value calculation unit 332, and a score calculation unit 334, accesses the storage unit 30, executes main processing in a game in the radio wave information measurement system, and outputs a processing result to the transmission unit 34.

The difference calculation unit 330 calculates, for each of the plurality of measurement positions, a difference between a predicted value stored in the storage unit 30 and a measured value received by the reception unit 31 for each user, and outputs a calculation result to the accumulated-value calculation unit 332.

The accumulated-value calculation unit 332 calculates, for each user, an accumulated value of differences calculated by the difference calculation unit 330 for each of the plurality of measurement positions, and outputs a calculation result to the score calculation unit 334.

The score calculation unit 334 calculates a score for each user such that a score value increases as the accumulated value calculated by the accumulated-value calculation unit 332 decreases, and outputs a calculation result to the transmission unit 34.

The transmission unit 34 transmits scores of the plurality of users calculated by the score calculation unit 334 to each of the wireless terminals 2.

That is, each user (each engineer) participates in a game in which the scores of the respective users transmitted from the server device 3 are each displayed on the wireless terminal 2. At this time, each user can know the scores of the other users, and can compete for the score with the other users.

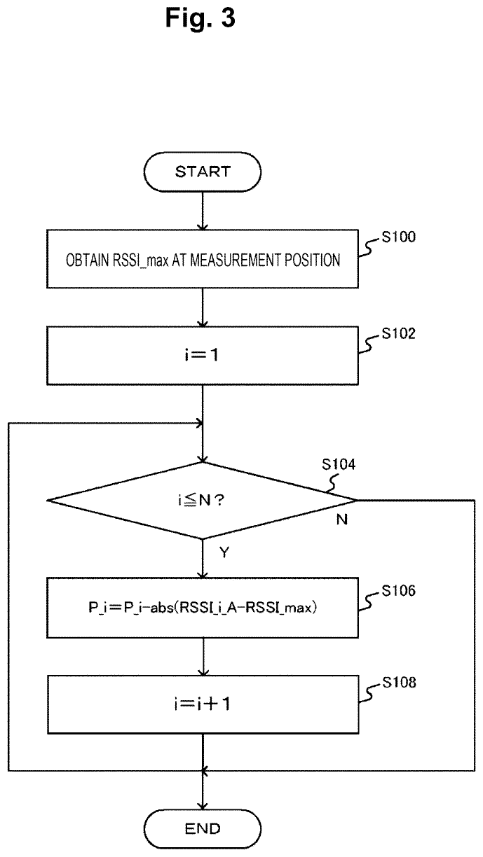

Next, a description will be given of a specific example of processing performed by the radio wave information measurement system according to the embodiment. FIG. 3 is a flowchart illustrating processing executed by the game execution unit 33 of the server device 3.

As illustrated in FIG. 3, the game execution unit 33 first obtains a maximum value (RSSI_max) of the RSSI at the measurement position of each user by using the RSSI transmitted from the wireless terminal 2 (S100). For example, when the reception unit 31 receives the RSSI of K base stations 10 from one wireless terminal 2, the game execution unit 33 obtains the maximum value RSSI_max from K RSSIs.

Next, the game execution unit 33 updates a value of points P_i held by an engineer i (1≤i≤N) in order from an engineer 1 (S102) as follows.

For example, the game execution unit 33 determines whether or not i≤N is satisfied (S104), proceeds to the processing of S106 in a case where i≤N is satisfied (S104: Yes), and ends the processing in a case where i≤N is not satisfied (S104: No).

In step 106 (S106), the game execution unit 33 performs calculation of a following formula (1).

$$P\_i = P\_i - abs ( RSSI\_i \_A - RSSI\_max ) \qquad ( 1 )$$

Here, RSSI i A is an RSSI value predicted at a measurement position A by the engineer i. The function abs ( ) is a function that returns an absolute value.

Then, the game execution unit 33 sets an engineer i=i+1 (S108), and returns to the processing of S104.

Thereafter, the server device 3 transmits P_i (1≤i≤N) to each of N wireless terminals 2 used by respective users participating in the game.

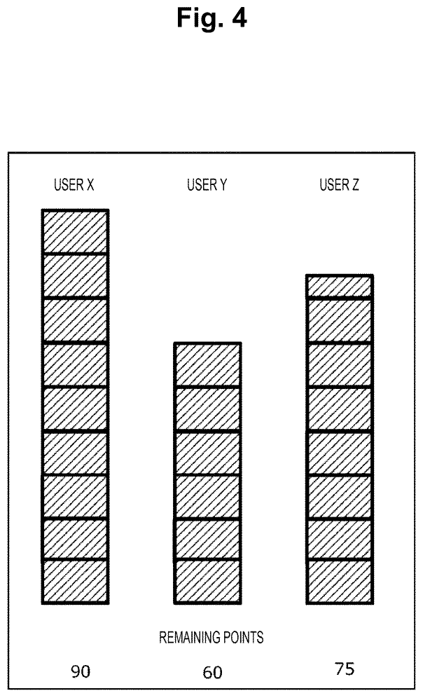

When the reception unit 24 receives P_i, each wireless terminal 2 outputs the value of P_i to the display unit 25. The display unit 25 of each of the wireless terminals 2 displays a game screen illustrated in FIG. 4.

The above-described formula (1) subtracts an absolute value of a difference between a predicted value predicted by a user and an actual measured value from points of the user. That is, a user with more remaining points (score) were able to predict the radio wave information better.

In this manner, by displaying the points of each user as a game screen on the display unit 25 of the wireless terminal 2, each user can improve the motivation to learn a necessary skill through the game.

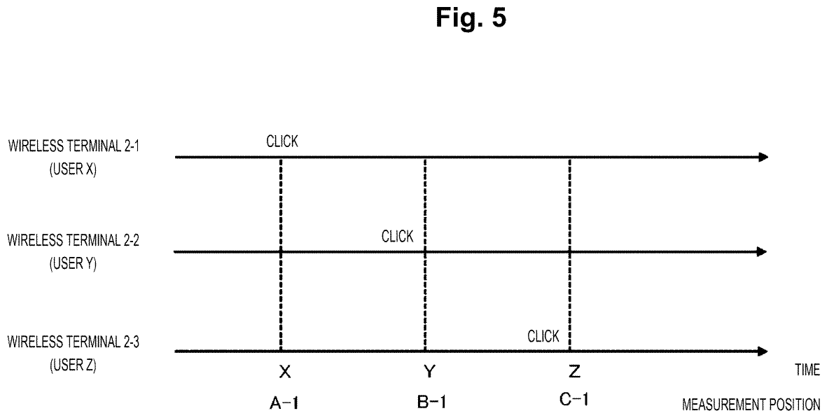

Next, a description will be given of an example of a case where a plurality of users executes the game using the radio wave information measurement system, with reference to FIGS. 5 to 8. Here, it is assumed that three users (X, Y, Z) each use one of three wireless terminals 2-1 to 2-3, and four or more base stations 10 are installed. Note that X, Y, and Z may be processed as having values of 1, 2, and 3, respectively.

As illustrated in FIG. 5, the user X clicks on the operation unit 21 at a timing of 1 second at a point A-1 that is a measurement position. The user Y clicks on the operation unit 21 at a timing of 2 seconds at a point B-1 that is a measurement position. The user Z clicks on the operation unit 21 at a timing of 3 seconds at a point C-1 that is a measurement position.

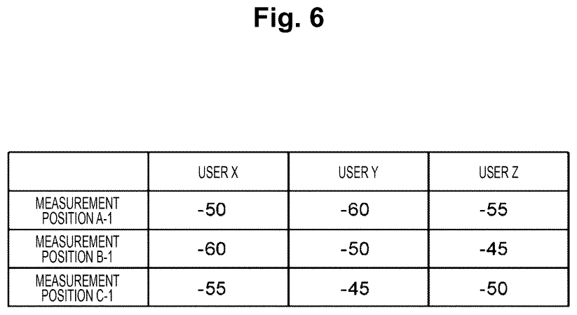

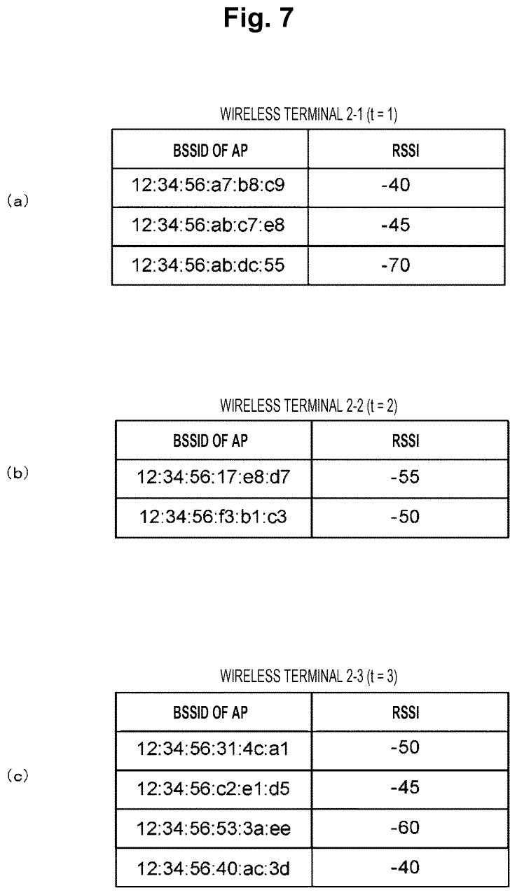

FIG. 6 is a diagram illustrating a predicted value of each user at each measurement position. FIG. 7 is a diagram illustrating values of RSSIs detected (measured) by the wireless terminals 2. FIG. 7 (a) is a diagram illustrating values of RSSIs detected (measured) by the wireless terminal 2-1. FIG. 7 (b) is a diagram illustrating values of RSSIs detected (measured) by the wireless terminal 2-2. FIG. 7 (c) is a diagram illustrating values of RSSIs detected (measured) by the wireless terminal 2-3.

At t=1 second, when the user X clicks on the drawing of the operation unit 21 of the wireless terminal 2 that matches the current location A-1 of the user X, the detection unit 22 executes channel scanning to detect (measure) the radio wave information illustrated in FIG. 6. The transmission unit 23 transmits the radio wave information (RSSI) as a measurement result and a measurement position number (A-1) to the server device 3.

The reception unit 31 of the server device 3 outputs the received radio wave information to the visualization unit 32 and the game execution unit 33.

The game execution unit 33 calculates P_i in accordance with the flowchart illustrated in FIG. 3. Here, an initial value of P_i is assumed to be, for example, 100.

When receiving RSSIs of radio waves transmitted by three base stations 10 as illustrated in FIG. 7 (a), the server device 3 obtains the maximum value RSSI_max from the three RSSIs. Here, the maximum value RSSI_max is −40.

The server device 3 updates points P_1, P_2, and P_3 as follows.

$$P\_ 1 = 100 - abs \{ ( - 50 ) - ( - 40 ) \} = 90$$

$$P\_ 2 = 100 - abs \{ ( - 60 ) - ( - 40 ) \} = 80$$

$$P\_ 3 = 100 - abs \{ ( - 55 ) - ( - 40 ) \} = 85$$

Then, the server device 3 transmits P_i (1≤i≤3) to each of the three wireless terminals 2 used by the respective users participating in the game.

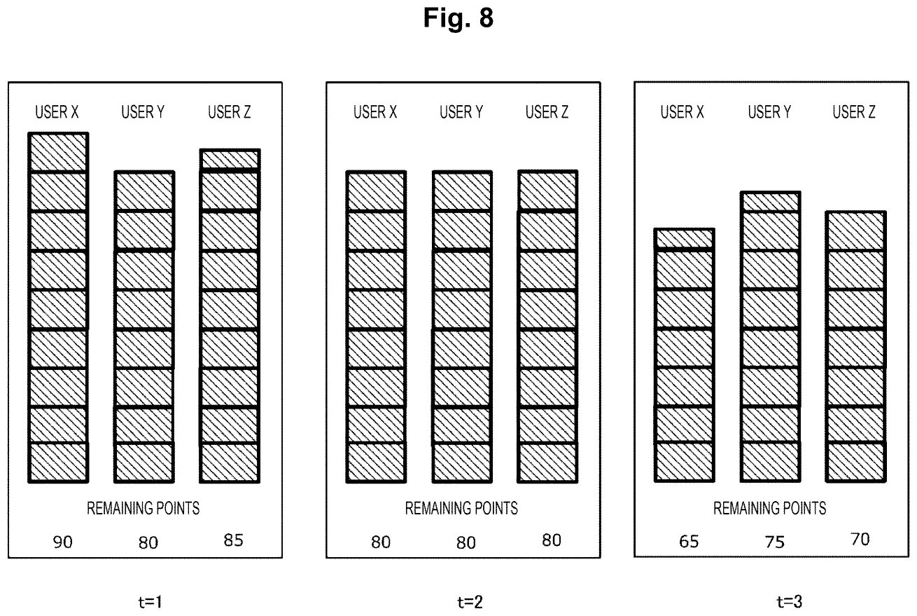

When the reception unit 24 receives P_i (1≤i≤3), the wireless terminal 2 outputs the value of P_i to the display unit 25. At this time, the display unit 25 of the wireless terminal 2 displays a game screen illustrated in FIG. 8.

At t=2 seconds, when the user Y clicks on the drawing of the operation unit 21 of the wireless terminal 2 that matches the current location B-1 of the user Y, the detection unit 22 executes channel scanning to detect (measure) the radio wave information illustrated in FIG. 6. The transmission unit 23 transmits the radio wave information (RSSI) as a measurement result and a measurement position number (B-1) to the server device 3.

The game execution unit 33 calculates P_i in accordance with the flowchart illustrated in FIG. 3.

When receiving RSSIs of radio waves transmitted by two base stations 10 as illustrated in FIG. 7 (b), the server device 3 obtains the maximum value RSSI_max from the two RSSIs. Here, the maximum value RSSI_max is −50.

The server device 3 updates points P_1, P_2, and P_3 as follows.

$$P\_ 1 = 90 - abs \{ ( - 60 ) - ( - 50 ) \} = 80$$

$$P\_ 2 = 80 - abs \{ ( - 50 ) - ( - 50 ) \} = 80$$

$$P\_ 3 = 85 - abs \{ ( - 45 ) - ( - 50 ) \} = 80$$

Then, the server device 3 transmits P_i (1≤i≤3) to each of the three wireless terminals 2 used by the respective users participating in the game.

When the reception unit 24 receives P_i (1≤i≤3), the wireless terminal 2 outputs the value of P_i to the display unit 25. At this time, the display unit 25 of the wireless terminal 2 displays a game screen illustrated in FIG. 8.

At t=3 seconds, when the user Z clicks on the drawing of the operation unit 21 of the wireless terminal 2 that matches the current location C-1 of the user Z, the detection unit 22 executes channel scanning to detect (measure) the radio wave information illustrated in FIG. 6. The transmission unit 23 transmits the radio wave information (RSSI) as a measurement result and a measurement position number (C-1) to the server device 3.

The game execution unit 33 calculates P_i in accordance with the flowchart illustrated in FIG. 3.

When receiving RSSIs of radio waves transmitted by four base stations 10 as illustrated in FIG. 7 (c), the server device 3 obtains the maximum value RSSI_max from the four RSSIs. Here, the maximum value RSSI_max is −40.

The server device 3 updates points P_1, P_2, and P_3 as follows.

$$P\_ 1 = 80 - abs \{ ( - 55 ) - ( - 40 ) \} = 65$$

$$P\_ 2 = 80 - abs \{ ( - 45 ) - ( - 40 ) \} = 75$$

$$P\_ 3 = 80 - abs \{ ( - 50 ) - ( - 40 ) \} = 70$$

Then, the server device 3 transmits P_i (1≤i≤3) to each of the three wireless terminals 2 used by the respective users participating in the game.

When the reception unit 24 receives P_i (1≤i≤3), the wireless terminal 2 outputs the value of P_i to the display unit 25. At this time, the display unit 25 of the wireless terminal 2 displays a game screen illustrated in FIG. 8.

As described above, in the radio wave information measurement system according to the embodiment, the game-like element is added to each of the wireless terminals 2 used by the respective users, so that it is possible to measure the radio wave information in construction of the wireless network and actively acquire the skill necessary for constructing the wireless network.

Note that some or all of the functions of the wireless terminal 2 and the server device 3 may be configured by hardware such as a programmable logic device (PLD) or a field programmable gate array (FPGA), or may be configured as a program executed by a processor such as a CPU.

For example, the server device 3 can be implemented by using a computer and a program, and the program can be recorded in a storage medium or provided through a network.

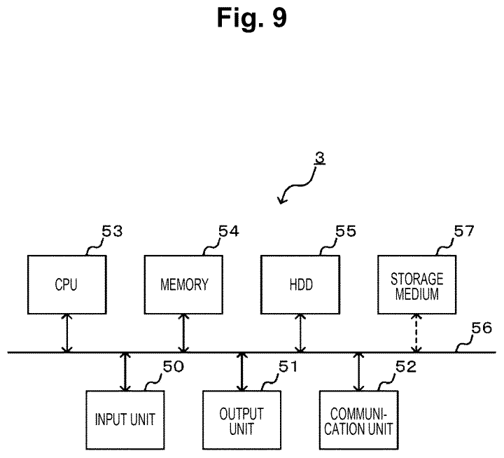

FIG. 9 is a diagram illustrating a hardware configuration example of the server device 3 according to the embodiment. As illustrated in FIG. 9, the server device 3, in which an input unit 50, an output unit 51, a communication unit 52, a CPU 53, a memory 54, and an HDD 55 are connected to each other via a bus 56, has a function as a computer. In addition, the server device 3 is made to be able to input and output data to and from a storage medium 57 that is computer-readable.

The input unit 50 is, for example, a keyboard, a mouse, or the like. The output unit 51 is, for example, a display device such as a display. In addition, the input unit 50 and the output unit 51 may constitute the operation unit 21 and the display unit 25 described above as a touch panel or the like.

The communication unit 52 is a communication interface that performs wireless communication by a wireless LAN or the like.

The CPU 53 controls each unit constituting the server device 3 and performs predetermined processing or the like. The memory 54 and the HDD 55 correspond to the above-described storage unit 30 or the like that stores data and the like.

The storage medium 57 is made to be able to store a program or the like executing a function of the server device 3. Note that an architecture that configures the server device 3 is not limited to the example illustrated in FIG. 9. In addition, the wireless terminal 2 may have the functions of the server device 3.

### REFERENCE SIGNS LIST

1 Predetermined area
2 Wireless terminal
3 Server device
10 Base station
12-1 to 12-3 Wireless terminal
14 Server device
20 Setting unit
21 Operation unit
22 Detection unit
23 Transmission unit
24 Reception unit
25 Display unit
30 Storage unit
31 Reception unit
32 Visualization unit
33 Game execution unit
34 Transmission unit
50 Input unit
51 Output unit
52 Communication unit
53 CPU
54 Memory
55 HDD
56 Bus
57 Storage medium
330 Difference calculation unit
332 Accumulated-value calculation unit
334 Score calculation unit

1. A radio wave information measurement system in which a plurality of users measures radio wave information regarding a radio wave transmitted by each of a plurality of base stations arranged at different positions in a predetermined area by respectively using wireless terminals that perform wireless communication with the base stations, the radio wave information measurement system comprising:
a memory that stores each of predicted values of the radio wave information, the predicted values being predicted, by each of the plurality of users, to be measured at a respective plurality of measurement positions preset in the predetermined area;
a receiver that receives each of measured values of the radio wave information, the measured values being measured at the respective plurality of measurement positions by each of the wireless terminals;
difference calculation circuitry that calculates, for each of the plurality of measurement positions, a difference between a predicted value stored in the memory and a measured value received by the receiver for each user;
accumulated-value calculation circuitry that calculates, for each user, an accumulated value of differences calculated for each of the plurality of measurement positions by the difference calculation circuitry;
score calculation circuitry that calculates a score for each user such that a score value increases as the accumulated value calculated by the accumulated-value calculation circuitry decreases; and
a transmitter that transmits scores of the plurality of users calculated by the score calculation circuitry to each of the wireless terminals,
wherein each of the wireless terminals includes a display that displays each of the scores of the plurality of users transmitted by the transmitter.

2. The radio wave information measurement system according to claim 1, wherein:
each of the wireless terminals measures, as the radio wave information, an RSSI of a radio wave transmitted by each of the plurality of base stations.

3. A radio wave information measurement method, comprising:
causing a memory to store predicted values of the radio wave information, the predicted values being predicted, by each of a plurality of users, to be measured at a respective plurality of measurement positions preset in the predetermined area;
receiving each of measured values of the radio wave information, the measured values being measured at the respective plurality of measurement positions by each of the wireless terminals;
calculating, for each of the plurality of measurement positions, a difference between a predicted value stored in the memory and a measured value received, for each user;
calculating, for each user, an accumulated value of differences calculated for each of the plurality of measurement positions;
calculating a score for each user such that a score value increases as the accumulated value calculated decreases;
transmitting scores of the plurality of users calculated to each of the wireless terminals; and
displaying, by each of the wireless terminals, the scores of the plurality of users transmitted.

4. The radio wave information measurement method according to claim 3, wherein:
each of the wireless terminals measures, as the radio wave information, an RSSI of a radio wave transmitted by each of the plurality of base stations.

5. A server whose clients are a plurality of wireless terminals that performs wireless communication with a plurality of base stations, the server comprising:
a memory that stores each of predicted values of radio wave information regarding a radio wave transmitted by each of the plurality of base stations arranged at different positions in a predetermined area, the predicted values being predicted, by a plurality of users, to be measured by each of the wireless terminals at a respective plurality of measurement positions preset in the predetermined area;
a receiver that receives each of measured values of the radio wave information, the measured values being measured at the respective plurality of measurement positions by each of the wireless terminals;
difference calculation circuitry that calculates, for each of the plurality of measurement positions, a difference between a predicted value stored in the memory and a measured value received by the receiver for each user;
accumulated-value calculation circuitry that calculates, for each user, an accumulated value of differences calculated for each of the plurality of measurement positions by the difference calculation circuitry;
score calculation circuitry that calculates a score for each user such that a score value increases as the accumulated value calculated by the accumulated-value calculation circuitry decreases; and
a transmitter that transmits scores of the plurality of users calculated by the score calculation circuitry to each of the wireless terminals.

6. The server device according to claim 5, wherein;
the receiver receives a measured value of an RSSI measured at each of the plurality of measurement positions by each of the wireless terminals as a measured value of the radio wave information.

7. A non-transitory computer readable medium storing program for causing a computer to perform the method of claim 3.
